(19) United States
(12) Patent Application Publication
(10) Pub. No.: US 2026/0291696 A1
(43) Pub. Date: Sep. 24, 2026

(54) METHOD AND APPARATUS FOR TWO-STAGE DOWNLINK CONTROL INFORMATION SCHEDULING IN MOBILE COMMUNICATIONS

(71) Applicant: MEDIATEK INC., Hsinchu City (TW)

(72) Inventors: Yi-Ju LIAO, Hsinchu City (TW); Pei-Kai LIAO, Hsinchu City (TW); Chi-Hsuan HSIEH, Hsinchu City (TW)

(73) Assignee: MEDIATEK INC., Hsinchu City (TW)

(21) Appl. No.: 19/473,179

(22) PCT Filed: Aug. 16, 2024
(86) PCT No.: PCT/CN2024/112747

§ 371 Date: Oct. 7, 2025

Related U.S. Application Data
(60) Provisional application No. 63/519,854, filed on Aug. 16, 2023.
(60) Provisional application No. 63/579,967, filed on Sep. 1, 2023.

(51) Int. Cl. H04L 5/00; H04L 1/00

(52) U.S. Cl. CPC H04L 5/0094; H04L 1/0061

(57) ABSTRACT

Various solutions for two-stage downlink control information (DCI) scheduling with respect to an apparatus in mobile communications are described. The apparatus may receive a first DCI associated with a second DCI. The apparatus may receive the second DCI according to the first DCI. The second DCI may include at least one multi-carrier DCI (MC-DCI). The apparatus may transceive data according to the at least one MC-DCI.

### CROSS REFERENCE TO RELATED PATENT APPLICATION(S)

The present disclosure is part of a non-provisional application claiming the priority benefits of U.S. Patent Application No. 63/519,854, filed on 16 Aug. 2023 and U.S. Patent Application No. 63/579,967, filed on 1 Sep. 2023, the contents of which herein being incorporated by reference in their entireties.

### TECHNICAL FIELD

The present disclosure is generally related to mobile communications and, more particularly, to two-stage downlink control information scheduling with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, downlink control information (DCI) is introduced. More specifically, DCI is transmitted from a network node to a user equipment (UE) over physical downlink control channel (PDCCH), and provides information associated with scheduling information, modulation and coding schemes, hybrid automatic repeat request (HARQ) processes, power control commands, etc. DCI ensures that the UE may effectively process incoming data and communicate back to the network node, which allows for dynamic and flexible management of network resources.

Various DCI formats serve different purposes. One such format is multi carrier-DCI (MC-DCI). Specifically, MC-DCI provides scheduling and resource allocation details across multiple component carriers (CCs) and reduces DCI overhead by consolidating information for scheduling up to four CCs into a single stage (or single segment) DCI, which may enable the UE to handle data transmissions on multiple carriers simultaneously.

However, the size of the MC-DCI is fixed. In other words, the size of the MC-DCI is not scalable. Further, regarding the MC-DCI, there are at least following issues: (1) redundant bits exist in MC-DCI when scheduled CCs are fewer than the maximum radio resource control (RRC) configured aggregated CC number, (2) higher aggregation level for non-scalable MC-DCI size adversely affects PDCCH blockage rate, and (3) higher physical downlink control channel (PDCCH) blockage rate leads to user throughput loss.

Accordingly, how to use MC-DCI more efficiently becomes an important issue in the newly developed wireless communication network. Therefore, there is a need to provide proper schemes to use MC-DCI more efficiently.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to multi carrier-downlink control information (MC-DCI) scheduling with respect to apparatus in mobile communications.

In one aspect, a method may involve an apparatus receiving a first DCI associated with a second DCI. The method may also involve the apparatus receiving the second DCI according to the first DCI. The second DCI may include at least one MC-DCI. The method may further involve the apparatus transceiving data according to the at least one MC-DCI.

In one aspect, a method may involve an apparatus transmitting a first DCI associated with a second DCI. The method may also involve the apparatus transmitting the second DCI according to the first DCI. The second DCI may include at least one MC-DCI. The method may further involve the apparatus transceiving data according to the at least one MC-DCI.

In one aspect, an apparatus may comprise a transceiver which, during operation, wirelessly communicates with a wireless network. The apparatus may also comprise a processor communicatively coupled to the transceiver. The processor, during operation, may perform operations comprising transmitting, via the transceiver, a first DCI associated with a second DCI. The processor may also perform operations comprising transmitting, via the transceiver, the second DCI according to the first DCI. The second DCI may include at least one MC-DCI. The processor may further perform operations comprising transmitting, via the transceiver, data according to the at least one MC-DCI.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a block diagram of an example communication system in accordance with an implementation of the present disclosure.

FIG. 10 is a flowchart of an example process in accordance with an implementation of the present disclosure.

FIG. 11 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to multi carrier-downlink control information (MC-DCI) scheduling with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may determine a first DCI and a second DCI. The first DCI may be associated with the second DCI. Specifically, the first DCI may include scheduling information regarding the second DCI. The network node may transmit the first DCI to a user equipment (UE). The UE may receive the first DCI.

After transmitting the first DCI including the scheduling information regarding the second DCI, the network node may transmit the second DCI to the UE according to the first DCI. The UE may receive the second DCI from the network node according to the first DCI. The second DCI may include at least one MC-DCI. Therefore, the network may transceive data with the UE according to the at least one MC-DCI.

Accordingly, as a result of employing a two-stage DCI approach (i.e., employing the first DCI and the second DCI), the flexibility in utilizing MC-DCI may be significantly enhanced so that the improved flexibility facilitates more precise and efficient scheduling, optimizing resource allocation and improving overall system performance.

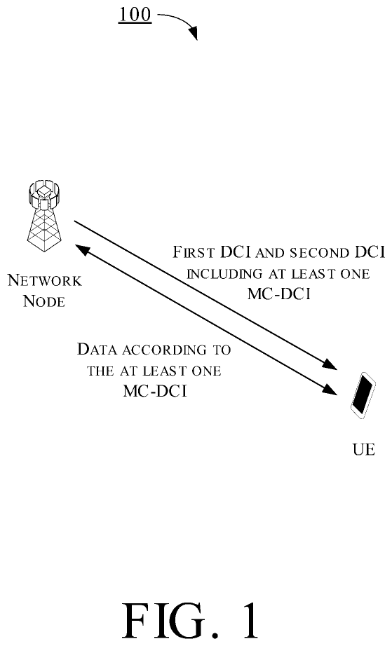

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may determine a first DCI and a second DCI. The first DCI may be associated with the second DCI. Specifically, the first DCI may include scheduling information regarding the second DCI. The network node may transmit the first DCI to the UE. The UE may perform blind detection for receiving the first DCI in a search space configured by a higher layer signaling (e.g., radio resource control (RRC) configuration).

After transmitting the first DCI including the scheduling information regarding the second DCI, the network node may transmit the second DCI to the UE according to the first DCI. Because the first DCI may include the scheduling information regarding the second DCI, the UE may receive the second DCI from the network node according to the first DCI without performing blind detection. The second DCI may include at least one MC-DCI, and each MC-DCI may schedule at least one physical downlink shared channel (PDSCH) and/or physical uplink shared channel (PUSCH) in scheduled carrier(s) (or cell(s)). Therefore, the network may transceive data with the UE according to the at least one MC-DCI.

In some implementations, the UE may receive and decode the second DCI when the associated first DCI is detected. In some implementations, the UE may perform data reception (e.g., PDSCH reception) or data transmission (e.g., PUSCH transmission) on scheduled serving carrier(s)/cell(s) according to the at least one MC-DCI in the second DCI.

In some implementations, whether to monitor two-stage DCI (i.e., whether to monitor the first DCI and the second DCI) may be configured in a higher layer signaling (e.g., UE-specific RRC) transmitted from the network node to the UE. In other words, the network node may transmit the higher layer signaling to the UE for enabling a function of two-stage DCI.

In some implementations, each of the at least one MC-DCI may include information of scheduling transmission of data on at least one carrier. In other words, each of the at least one MC-DCI may include PUSCH scheduling information or PDSCH scheduling information on at least one carrier.

In some implementations, each of the at least one MC-DCI may include information of scheduling transmission of data in at least one slot. In other words, each of the at least one MC-DCI may include PUSCH scheduling information or PDSCH scheduling information in at least one slot.

In some implementations, each of the at least one MC-DCI may include information of scheduling the data to one UE, which means that each of the at least one MC-DCI may be a UE-specific MC-DCI. In other words, different MC-DCI may include PUSCH scheduling information or PDSCH scheduling information for different UEs in at least one carrier (or at least one slot). In some cases, a radio network temporary identifier (RNTI), which may be an initial seed for demodulation reference signal (DMRS) generation, and a PDCCH scrambling sequence for the first DCI may be common to a group of UEs and may be configured by the higher layer signaling. In some cases, the RNTI (e.g., cell-RNTI (C-RNTI)) for each of the at least one MC-DCI in the second DCI may be specific to each UE.

In some implementations, to achieve the purpose of offloading, a cell for scheduling the UE may be switched from the network node (e.g., primary cell) to another network node (e.g., a secondary cell) according to a carrier switching procedure based on a semi-static pattern defined in the RRC signaling or a dynamic indication.

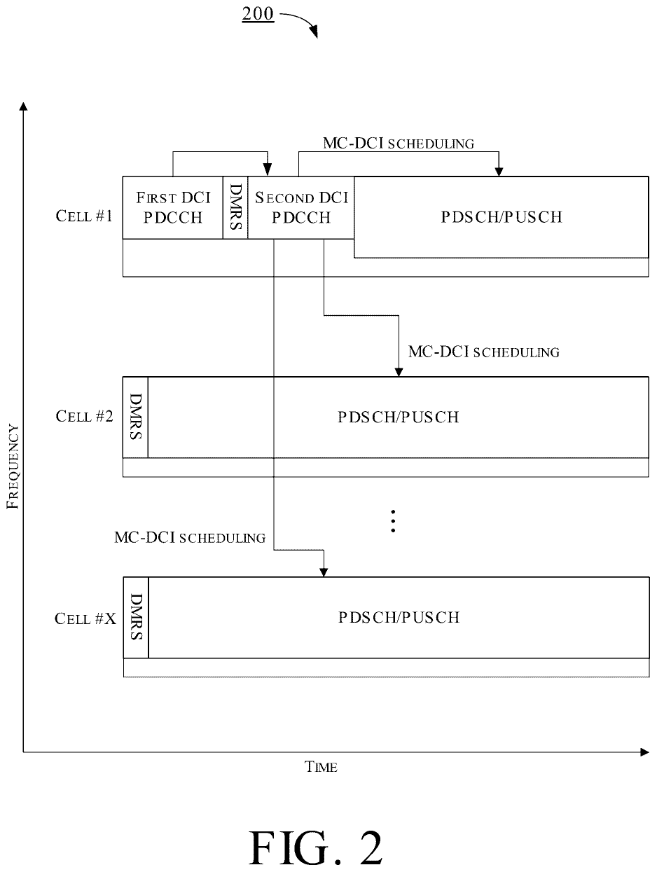

FIG. 2 illustrates an example scenario 200 under schemes in accordance with implementations of the present disclosure. In some embodiments, the network node may transmit the first DCI via physical downlink control channel (PDCCH). The first DCI may include the scheduling information of the second DCI. The network may transmit DMRS for the UE to receive the second DCI according to the first DCI including the scheduling information of the second DCI. The second DCI may be transmitted via PDCCH. The second DCI may include the at least one MC-DCI while each MC-DCI may schedule at least one PDSCH and/or PUSCH in scheduled carrier(s)/cell(s). For example, the second DCI includes ‘X’ number of MC-DCIs while each MC-DCI schedules PDSCH or PUSCH in scheduled cell #1 to cell #X.

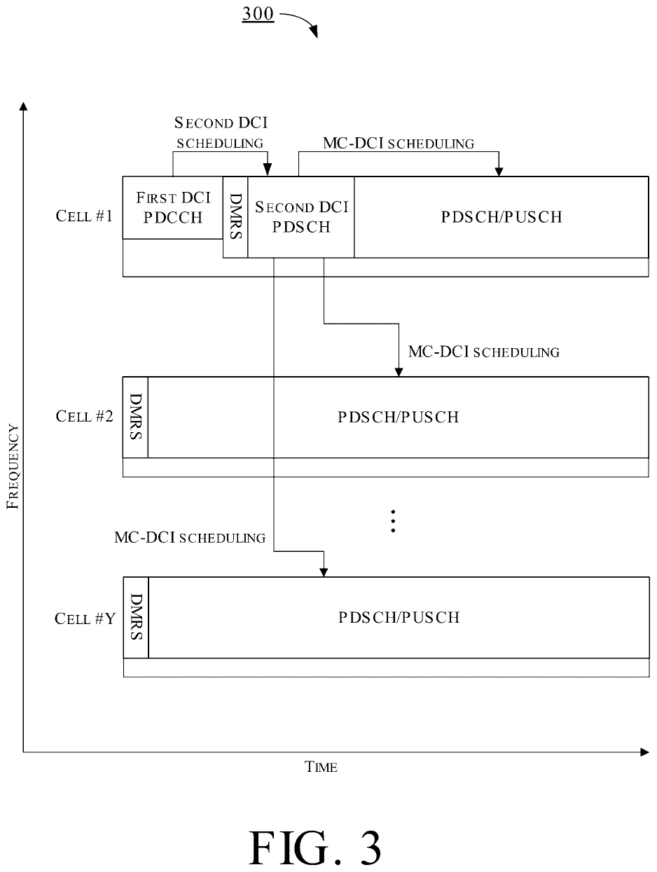

FIG. 3 illustrates an example scenario 300 under schemes in accordance with implementations of the present disclosure. In some embodiments, the network node may transmit the first DCI via PDCCH. The first DCI may include the scheduling information of the second DCI. The network may transmit DMRS for the UE to receive the second DCI according to the first DCI including the scheduling information of the second DCI. The second DCI may be transmitted by DCI-dedicated PDSCH. The second DCI may include the at least one MC-DCI while each MC-DCI may schedule at least one PDSCH and/or PUSCH in scheduled carrier(s)/cell(s). For example, the second DCI includes ‘Y’ number of MC-DCIs while each MC-DCI schedules PDSCH or PUSCH in scheduled cell #1 to cell #Y.

In some implementations, the first DCI and each MC-DCI in the second DCI may be encoded by some code schemes (e.g., polar code scheme). In some implementations, each MC-DCI in the second DCI may have a DCI format (e.g., DCI format 0_3 or DCI format 1_3 defined in 3^{rd} generation partnership project (3GPP) specification).

In some implementations, the first DCI may include a field indicating whether the first DCI is associated with the second DCI. In particular, the field may be used for differentiating that the first DCI is a DCI including norma DCI format (e.g., DCI format 0_0 or DCI format 1_1 defined in 3GPP specification) or the first DCI is the first DCI of two-stage DCI of the present disclosure. For example, the field includes 1 bit where ‘0’ indicates that the first DCI is not associated with the second DCI and ‘1’ indicates the first DCI is associated with the second DCI. In other words, the field includes 1 bit where ‘0’ indicates that the first DCI is the normal DCI and ‘1’ indicates that the first DCI is used for two-stage DCI. In some cases, a size of the first DCI may be aligned to a size of a fallback DCI so that, comparing a blind detection number for the fallback DCI, a blind detection number for the first DCI of the present disclosure may not increase. In some cases, the field may be allocated in the beginning of the first DCI.

In some implementations, the first DCI or the second DCI include a field indicating a presence of the at least one MC-DCI. In particular, the at least one MC-DCI in the second DCI may be indexed by the higher layer signaling (e.g. UE-specific RRC signaling). Each bit of the field may indicate the presence of each MC-DCI according to an order of the indexed MC-DCI(s). For example, four MC-DCIs are configured and indexed as 1, 2, 3, 4 by the network node. The field includes four bits (e.g., bit map) for indicating the presences of the MC-DCIs. When MC-DCI #1 and MC-DCI #3 are used and included in the second DCI, the field is represented as ‘1010’. When MC-DCI 190 1, MC-DCI #3 and MC-DCI #4 are used and included in the second DCI, the field is represented as ‘1011’. In some cases, the field indicating the presence of the at least one MC-DCI may be included in the first DCI. In some cases, the field indicating the presence of the at least may be included in the second DCI.

In some implementations, the first DCI or the second DCI may include a field indicating whether the at least one MC-DCI is for downlink (DL) or uplink (UL). In some cases, the field may indicate that two-stage DCI (i.e., the first DCI and the second DCI) may schedule either DL (e.g., PDSCH) or UL (e.g., PUSCH). In some cases, the field may indicate that two-stage DCI (i.e., the first DCI and the second DCI) may schedule both DL (e.g., PDSCH) and UL (e.g., PUSCH) jointly. In some cases, the field indicating whether the at least one MC-DCI is for DL or UL may be included in the first DCI. In some cases, the field indicating whether the at least one MC-DCI is for DL or uplink UL may be included in the second DCI.

In some implementations, the scheduling information included in the first DCI may include an indication of resource information of the second DCI. In particular, the network node may transmit the higher layer signaling (e.g., UE-specific RRC signaling) to the UE for configuring a plurality of configuration sets for the second DCI. Each configuration set may include resource information. The scheduling information included in the first DCI may include the indication indicating which configuration set to be used for receiving the second DCI. In some cases, a number N of the plurality of configuration sets may be greater than 1, and the scheduling information may include [log₂ N] bits. In these implementations, signaling overhead may be lower and UE processing timeline may be better (e.g., UE implementation may decode all possibilities before finishing the first DCI decoding).

In some implementations, the scheduling information included in the first DCI may include the resource information of the second DCI. In particular, the scheduling information included in the first DCI may directly include all the resource information needed for receiving the second DCI. In these cases, the flexibility of scheduling may be better.

In some implementations, the scheduling information may include: frequency domain resource assignment, time domain resource assignment, virtual resource block-to-physical resource block (VRB-to-PRB) mapping (or interleaved or non-interleaved mapping), modulation and coding scheme, redundancy version (e.g., RV0, RV3, self-decodable RV defined in the 3GPP specification), DMRS configuration, Transmission Configuration Indicator (TCI) state and reserved bits. In some cases, regarding the DMRS configuration, the UE may understand whether DMRS of the second DCI is shared with scheduled PDSCH in the same bandwidth part (BWP), carrier or cell.

In some implementations, field sizes in the first DCI and the second may be scalable. In particular, the UE may determine the field sizes based on a higher layer signaling (e.g., UE-specific RRC signaling) transmitted from the network node. In some cases, a format of the second DCI may be configured grant like method (i.e., the indication of the resource information of the second DCI) or fully dynamic scheduling method (i.e., the resource information of the second DCI). In some cases, granularity of frequency domain resource allocation may be, for example, 2 resource block (RB), 6 RB or full band. In some cases, a maximum number of MC-DCIs may be scheduled in the second DCI.

In some implementations, a same C-RNTI may be used for both the first DCI and the second DCI.

In some implementations, each of the at least one MC-DCI may be encoded with a code and includes a cyclic redundancy check (CRC). In particular, each of the at least one MC-DCI in the second DCI may include its own CRC and be encoded by the code (e.g., polar code) separately. In other words, each of the at least one of MC-DCI may be an individual code block (e.g., polar code block), and UE may decode each code block individually.

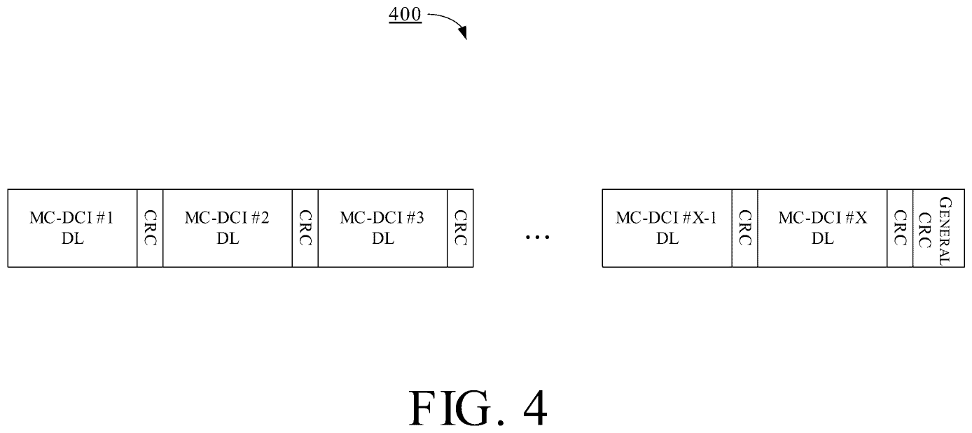

FIG. 4 illustrates an example scenario 400 under schemes in accordance with implementations of the present disclosure. In some cases, each of the at least one MC-DCI in the second DCI may include its own CRC and be encoded by the code (e.g., polar code) separately. In some cases, all MC-DCI may have same type (e.g., DL or UL). For example, MC-DCI #1 to MC-DCI #X have the DL type. In some cases, a general CRC may be optional for all MC-DCIs.

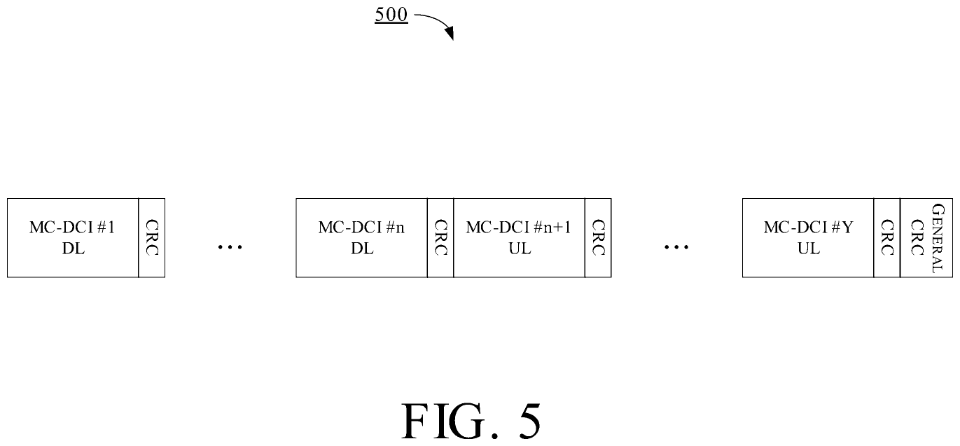

FIG. 5 illustrates an example scenario 500 under schemes in accordance with implementations of the present disclosure. In some cases, each of the at least one MC-DCI in the second DCI may include its own CRC and be encoded by the code (e.g., polar code) separately. In some cases, the at least one MC-DCI may have different types (e.g., DL or UL). For example, MC-DCI #1 to MC-DCI #n have the DL type and MC-DCI #n+1 to MC-DCI #Y have the UL type. In some cases, a general CRC may be optional for all MC-DCIs.

In some implementations, all of the at least one MC-DCI may be encoded with a code and includes a CRC. In particular, all of the at least one MC-DCI in the second DCI may include one CRC and be encoded by the code (e.g., polar code or low density parity check (LDPC) code) jointly. In other words, all of the at least one of MC-DCI may be considered as a code block, and UE may decode the code block.

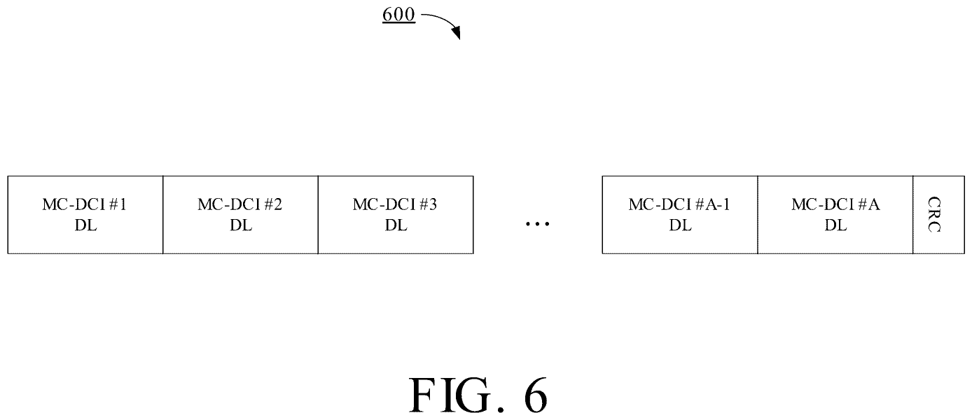

FIG. 6 illustrates an example scenario 600 under schemes in accordance with implementations of the present disclosure. In some cases, all of the at least one MC-DCI in the second DCI may include one CRC and be encoded by the code (e.g., polar code or LDPC code) jointly. In some cases, all MC-DCI may have same type (e.g., DL or UL). For example, MC-DCI #1 to MC-DCI #A have the DL type.

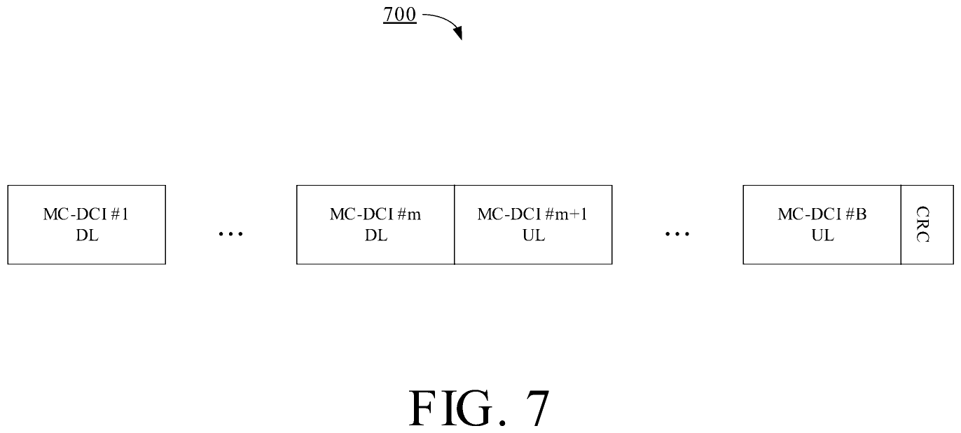

FIG. 7 illustrates an example scenario 700 under schemes in accordance with implementations of the present disclosure. In some cases, all of the at least one MC-DCI in the second DCI may include one CRC and be encoded by the code (e.g., polar code or LDPC code) jointly. In some cases, the at least one MC-DCI may have different types (e.g., DL or UL). For example, MC-DCI #1 to MC-DCI #m have the DL type and MC-DCI #m+1 to MC-DCI #B have the UL type.

In some implementations, a first part of the at least one MC-DCI may be encoded with a first code and includes a first CRC while a second part of the at least one MC-DCI may be encoded with a second code and includes a second CRC. In particular, the first part of the at least one MC-DCI in the second DCI may include their own first CRC and be encoded by the first code (e.g., polar code) jointly. The second part of the at least one MC-DCI in the second DCI may include their own second CRC and be encoded by the second code (e.g., polar code) jointly. In other words, the first part of the at least one of MC-DCI may be considered as an individual code block while the second part of the at least one of MC-DCI may be considered as another individual code block, and the UE may decode the code blocks individually.

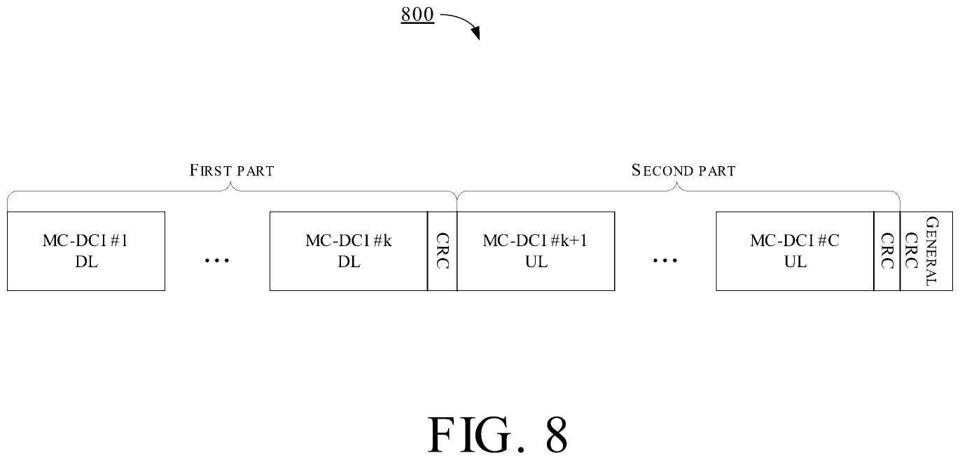

FIG. 8 illustrates an example scenario 800 under schemes in accordance with implementations of the present disclosure. In some cases, the first part of the at least one MC-DCI in the second DCI may include their own first CRC and be encoded by the code (e.g., polar code) jointly. The second part of of the at least one MC-DCI in the second DCI may include their own second CRC and be encoded by the second code (e.g., polar code) jointly. In some cases, the first part of the at least one MC-DCI may have type (e.g., DL or UL) while the second part of the at least one MC-DCI may have different type (e.g., UL or DL). For example, MC-DCI #1 to MC-DCI #k (i.e., the first part MC-DCI) have the DL type and MC-DCI #k+1 to MC-DCI #C (i.e., the second part MC-DCI) have the UL type. In some cases, a general CRC may be optional for all MC-DCIs.

### Illustrative Implementations

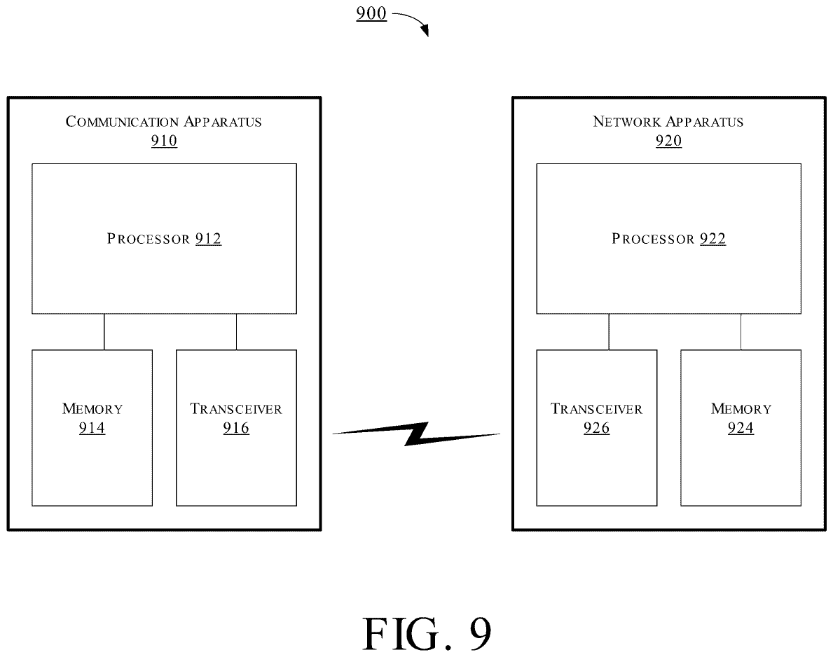

FIG. 9 illustrates an example communication system 900 having an example communication apparatus 910 and an example network apparatus 920 in accordance with an implementation of the present disclosure. Each of communication apparatus 910 and network apparatus 920 may perform various functions to implement schemes, techniques, processes and methods described herein pertaining to SR enhancement with respect to UE and network apparatus in mobile communications, including scenarios/schemes described above as well as processes 1000 and 1100 described below.

Communication apparatus 910 may be a part of an electronic apparatus, which may be a UE such as a portable or mobile apparatus, a wearable apparatus, a wireless communication apparatus or a computing apparatus. For instance, communication apparatus 910 may be implemented in a smartphone, a smartwatch, a personal digital assistant, a digital camera, or a computing equipment such as a tablet computer, a laptop computer or a notebook computer. Communication apparatus 910 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 910 may be implemented in a smart thermostat, a smart fridge, a smart door lock, a wireless speaker or a home control center. Alternatively, communication apparatus 910 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 910 may include at least some of those components shown in FIG. 9 such as a processor 912, for example. Communication apparatus 910 may further include one or more other components not pertinent to the proposed scheme of the present disclosure (e.g., internal power supply, display device and/or user interface device), and, thus, such component(s) of communication apparatus 910 are neither shown in FIG. 9 nor described below in the interest of simplicity and brevity.

Network apparatus 920 may be a part of a network apparatus, which may be a network node such as a satellite, a base station, a small cell, a router or a gateway. For instance, network apparatus 920 may be implemented in an eNodeB in an LTE network, in a gNB in a 5G/NR, IoT, NB-IoT or IIoT network or in a satellite or base station in a 6G network. Alternatively, network apparatus 920 may be implemented in the form of one or more IC chips such as, for example and without limitation, one or more single-core processors, one or more multi-core processors, or one or more RISC or CISC processors. Network apparatus 920 may include at least some of those components shown in FIG. 9 such as a processor 922, for example. Network apparatus 920 may further include one or more other components not pertinent to the proposed scheme of the present disclosure (e.g., internal power supply, display device and/or user interface device), and, thus, such component(s) of network apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including two-stage DCI scheduling in a device (e.g., as represented by communication apparatus 910) and a network (e.g., as represented by network apparatus 920) in accordance with various implementations of the present disclosure.

In some implementations, communication apparatus 910 may also include a transceiver 916 coupled to processor 912 and capable of wirelessly transmitting and receiving data. In other words, processor 912 may transceive the data such as configuration, message, signal, information, indicator, etc. via transceiver 916. In some implementations, communication apparatus 910 may further include a memory 914 coupled to processor 912 and capable of being accessed by processor 912 and storing data therein. In some implementations, network apparatus 920 may also include a transceiver 926 coupled to processor 922 and capable of wirelessly transmitting and receiving data. In other words, processor 922 may transceive the data such as configuration, message, signal, information, indicator, etc. via transceiver 926. In some implementations, network apparatus 920 may further include a memory 924 coupled to processor 922 and capable of being accessed by processor 922 and storing data therein. Accordingly, communication apparatus 910 and network apparatus 920 may wirelessly communicate with each other via transceiver 916 and transceiver 926, respectively. To aid better understanding, the following description of the operations, functionalities and capabilities of each of communication apparatus 910 and network apparatus 920 is provided in the context of a mobile communication environment in which communication apparatus 910 is implemented in or as a communication apparatus or a UE and network apparatus 920 is implemented in or as a network node of a communication network.

In some implementations, each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

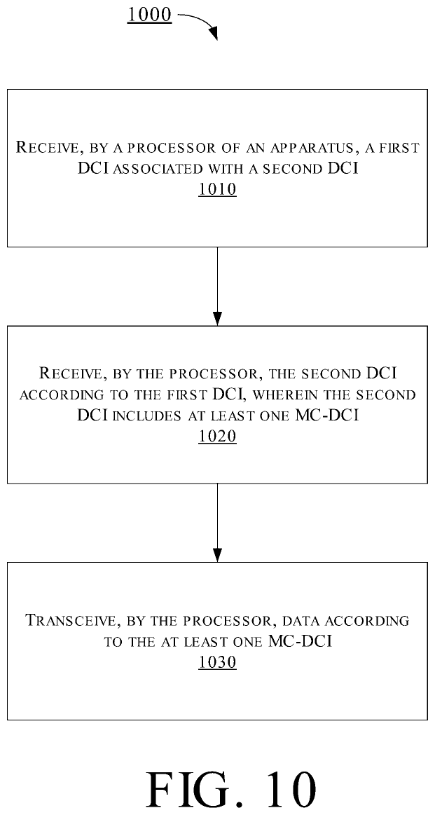

FIG. 10 illustrates an example process 1000 in accordance with an implementation of the present disclosure. Process 1000 may be an example implementation of above scenarios/schemes, whether partially or completely, with respect to two-stage DCI of the present disclosure. Process 1000 may represent an aspect of implementation of features of communication apparatus 910. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by communication apparatus 910 or any suitable UE or machine type devices. Solely for illustrative purposes and without limitation, process 1000 is described below in the context of communication apparatus 910. Process 1000 may begin at block 1010.

At block 1010, process 1000 may involve processor 912 of communication apparatus 910 receiving a first DCI associated with a second DCI. Process 1000 may proceed from block 1010 to block 1020.

At block 1020, process 1000 may involve processor 912 of communication apparatus 910 receiving the second DCI according to the first DCI. The second DCI may include at least one MC-DCI. Process 1000 may proceed from block 1020 to block 1030.

At block 1030, process 1000 may involve processor 912 of communication apparatus 910 transceiving data according to the at least one MC-DCI.

In some implementations, the first DCI may include scheduling information of the second DCI.

In some implementations, the scheduling information may include resource information of the second DCI or an indication of the resource information of the second DCI.

In some implementations, each of the at least one MC-DCI may include information of: scheduling the data on at least one carrier; or scheduling the data in at least one slot.

In some implementations, the first DCI may include a field indicating whether the first DCI is associated with the second DCI.

In some implementations, the first DCI or the second DCI may include a field indicating a presence of the at least one MC-DCI.

In some implementations, the first DCI or the second DCI may include a field indicating whether the at least one MC-DCI is for DL or UL.

In some implementations, each of the at least one MC-DCI may be encoded with a code and include a CRC.

In some Implementations, the at least one MC-DCI may be encoded with a code and include a CRC.

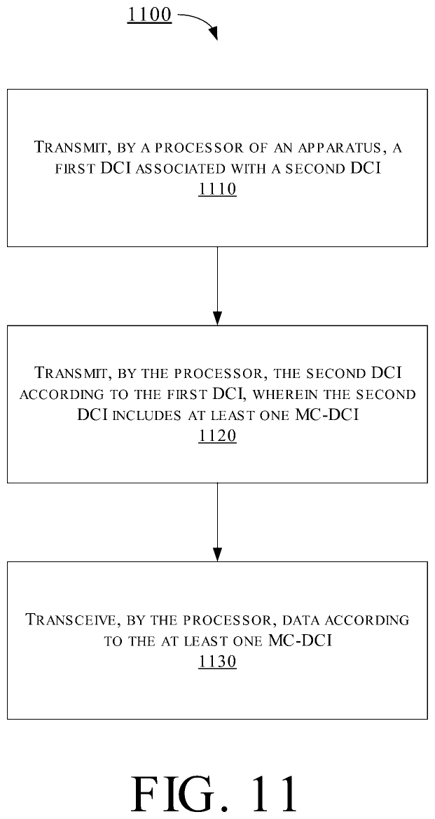

FIG. 11 illustrates an example process 1100 in accordance with an implementation of the present disclosure. Process 1100 may be an example implementation of above scenarios/schemes, whether partially or completely, with respect to two-stage DCI of the present disclosure. Process 1100 may represent an aspect of implementation of features of network apparatus 920. Process 1100 may include one or more operations, actions, or functions as illustrated by one or more of blocks 1110 to 1130. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Process 1100 may be implemented by network apparatus 920 or any suitable network device or machine type devices. Solely for illustrative purposes and without limitation, process 1100 is described below in the context of network apparatus 920. Process 1100 may begin at block 1110.

At block 1110, process 1100 may involve processor 922 of network apparatus 920 transmitting a first DCI associated with a second DCI. Process 1100 may proceed from block 1110 to block 1120.

At block 1120, process 1100 may involve processor 922 of network apparatus 920 transmitting the second DCI according to the first DCI. The second DCI may include at least one MC-DCI. Process 1100 may proceed from block 1120 to block 1130.

At block 1130, process 1100 may involve processor 922 of network apparatus 920 transceiving data according to the at least one MC-DCI.

In some implementations, the first DCI may include scheduling information of the second DCI.

In some implementations, the scheduling information may include resource information of the second DCI or an indication of the resource information of the second DCI.

In some implementations, each of the at least one MC-DCI may include information of: scheduling the data on at least one carrier; or scheduling the data in at least one slot.

In some implementations, each of the at least one MC-DCI may include information of scheduling the data to a UE.

In some implementations, the first DCI may include a field indicating whether the first DCI is associated with the second DCI.

In some implementations, the first DCI or the second DCI may include a field indicating a presence of the at least one MC-DCI.

In some implementations, the first DCI or the second DCI may include a field indicating whether each of the at least one MC-DCI is for DL or UL.

In some implementations, each of the at least one MC-DCI may be encoded with a code and include a CRC.

In some implementations, the at least one MC-DCI may be encoded with a code and include a CRC.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first downlink control information (DCI) associated with a second DCI;
receiving, by the processor, the second DCI according to the first DCI, wherein the second DCI includes at least one multi-carrier DCI (MC-DCI); and
transceiving, by the processor, data according to the at least one MC-DCI.

2. The method of claim 1, wherein the first DCI includes scheduling information of the second DCI.

3. The method of claim 2, wherein the scheduling information includes resource information of the second DCI or an indication of the resource information of the second DCI.

4. The method of claim 1, wherein each of the at least one MC-DCI includes information of:
scheduling the data on at least one carrier; or
scheduling the data in at least one slot.

5. The method of claim 1, wherein the first DCI includes a field indicating whether the first DCI is associated with the second DCI.

6. The method of claim 1, wherein the first DCI or the second DCI includes a field indicating a presence of the at least one MC-DCI.

7. The method of claim 1, wherein the first DCI or the second DCI includes a field indicating whether the at least one MC-DCI is for downlink or uplink.

8. The method of claim 1, wherein each of the at least one MC-DCI is encoded with a code and includes a cyclic redundancy check.

9. The method of claim 1, wherein the at least one MC-DCI is encoded with a code and includes a cyclic redundancy check.

10. A method, comprising:
transmitting, by a processor of an apparatus, a first downlink control information (DCI) associated with a second DCI;
transmitting, by the processor, the second DCI according to the first DCI, wherein the second DCI includes at least one multi-carrier DCI (MC-DCI); and
transceiving, by the processor, data according to the at least one MC-DCI.

11. The method of claim 10, wherein the first DCI includes scheduling information of the second DCI.

12. The method of claim 11, wherein the scheduling information includes resource information of the second DCI or an indication of the resource information of the second DCI.

13. The method of claim 10, wherein each of the at least one MC-DCI includes information of:
scheduling the data on at least one carrier;
scheduling the data in at least one slot.

14. The method of claim 10, wherein each of the at least one MC-DCI includes information of scheduling the data to a user equipment (UE).

15. The method of claim 10, wherein the first DCI includes a field indicating whether the first DCI is associated with the second DCI.

16. The method of claim 10, wherein the first DCI or the second DCI includes a field indicating a presence of the at least one MC-DCI.

17. The method of claim 10, wherein the first DCI or the second DCI includes a field indicating whether each of the at least one MC-DCI is for downlink or uplink.

18. The method of claim 10, wherein each of the at least one MC-DCI is encoded with a code and includes a cyclic redundancy check.

19. The method of claim 10, wherein the at least one MC-DCI is encoded with a code and includes a cyclic redundancy check.

20. An apparatus, comprising:
a transceiver which, during operation, wirelessly communicates with a wireless network; and
a processor communicatively coupled to the transceiver such that, during operation, the processor performs operations comprising:
transmitting, via the transceiver, a first downlink control information (DCI) associated with a second DCI;
transmitting, via the transceiver, the second DCI according to the first DCI, wherein the second DCI includes at least one multi-carrier DCI (MC-DCI); and
transceiving, via the transceiver, data according to the at least one MC-DCI.
